(19) United States
(12) Patent Application Publication
(10) Pub. No.: US 2004/0006667 A1
(43) Pub. Date: Jan. 8, 2004

(54) Apparatus and method for implementing adjacent, non-unit stride memory access patterns utilizing SIMD instructions

(76) Inventors: Aart J.C. Bik, Union City, CA (US); Milind Girkar, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/177,556

(22) Filed: Jun. 21, 2002

(51) Int. Cl. G06F 12/00; G06F 12/14; G06F 12/16; G06F 13/00; G06F 13/28; G06F 9/45

(52) U.S. Cl. 711/100

(57) ABSTRACT

An apparatus and method for implementing adjacent, single non-unit stride memory access patterns are described. In one embodiment, the method includes compiler analysis of a source program to detect vectorizable loops having serial code statements that collectively perform adjacent, non-unit stride memory access. Once a vectorizable loop containing code statements that collectively perform adjacent, non-unit stride memory access in detected, the compiler vectorizes the serial code statements of the detected loop to perform the adjacent, non-unit stride memory access utilizing SIMD instructions. As such, the compiler repeats the analysis and vectorization for each vectorizable loop within the source program code.

### FIELD OF THE INVENTION

One or more embodiments of the invention relate generally to the field of compilers. More particularly, one embodiment of the invention relates to a method and apparatus for implementing adjacent, non-unit stride memory access patterns utilizing single instruction, multiple data (SIMD) instructions.

### BACKGROUND OF THE INVENTION

Computer designers are faced with the task of designing systems that must meet continually expanding performance requirements. At an architectural level, many advances either reducing latency (the time between start and completion of an operation), or increasing bandwidth (the width and rate of operations). At the semiconductor level, the speed of circuits has increased, while packaging densities have been enhanced to obtain higher performance. However, due to physical limitations on the speed of electronic components, other performance enhancing approaches have also been taken. In fact, a current architectural advance, which provides significant performance improvement in execution bandwidth, was first conceived during the early days of supercomputing.

The early days of supercomputing realized an architectural advantage by utilizing data parallelism to design legacy vector architectures with improved execution bandwidth. This form of parallelism arises in many numerical applications in science, engineering and image processing, where a single operation is applied to multiple elements in the data set (“data parallelism”), usually a vector or matrix. One way to utilize data parallelism that has proven effective in early processors is data pipelining. In this approach, vectors of data stream directly from memory or vector registers to and from pipelined functional units of the legacy vector architectures.

However, exploiting data parallelism requires the conversion of serial code into parallel instructions to achieve optimum performance. One technique for rewriting serial code into a form that enables simultaneous, or parallel, processing of an instruction on multiple data elements is the single instruction, multiple data (SIMD) technique. Unfortunately, the task of transforming serial code into parallel instructions, such as SIMD instructions, is often a cumbersome task for programmers. As described herein, rewriting of serial code into a form that exploits instruction parallelism provided by, for example, SIMD techniques, is referred to as “vectorization”.

As described above, the SIMD technique provides a significant enhancement to execution bandwidth in mainstream computing. According to the SIMD approach, multiple functional units operate simultaneously on so-called “packed data elements” (relatively short vectors that reside in memory or registers). As a result, since a single instruction processes multiple data elements in parallel, this form of instruction level parallelism provides a new way to utilize data parallelism first devised during the early days of supercomputers. Accordingly, recent extensions to computing architectures utilize the SIMD technique to design architectures that support streaming SIMD extensions (SSE/SSE2), which are referred to herein as “SIMD Extension Architectures”. As a result, SIMD Extension Architectures enhance the performance of computationally intensive applications by utilizing a single operation which simultaneously processes different elements in a data set.

Unfortunately, much of the code that exploits these recent SIMD extensions, must be hand-coded by the programmer. Moreover, in order to benefit from the SIMD technique utilized in current architectural advancements, legacy code must be rewritten in order to utilize the SIMD architectural advances provided. One technique for automatically converting serial code into an SIMD form is provided by compiler conversion of serial code into an SIMD format, which is referred to herein as “vectorizing serial program code”.

Unfortunately, current compiler optimization techniques utilized by vectorizing compilers for vectorizing serial program code into an SIMD format are limited to program loops that exhibit regular memory access patterns. In other words, current compiler optimizations are limited to serial code which performs unit-stride memory access. As known to those skilled in the art, unit-stride memory access refers to memory access where subsequent memory access iterations within a loop access adjacent elements in memory. As a result, when a current vectorizing compiler encounters non-unit stride memory references, the compiler has to resort to implementing the detected loop using scalar instructions, or vectorizing other portions of the loop, while scalar shuffle/unpack instructions are used to implement the non-unit stride references.

As recognized by those skilled in the art, scalar implementations clearly disable any performance gain that is obtained utilizing architectural advances provided by the vectorization. In addition, implementing non-unit stride references utilizing vector code combined scalar shuffle/unpack instructions results in instruction sequences that are usually too expensive to exhibit any speed-up compared to purely scalar versions. Therefore, there remains a need to overcome one or more of the limitations in the above-described, existing art.

### BRIEF DESCRIPTION OF THE DRAWINGS

The various embodiments of the present invention are illustrated by way of example, and not by way of limitation, in the figures of the accompanying drawings and in which:

FIG. 1 depicts a block diagram illustrating a computer system implementing a system compiler to vectorize serial code statements that collectively performing adjacent, non-unit stride memory access, utilizing SIMD instructions, in accordance with one embodiment of the present invention.

FIG. 2 depicts a block diagram further illustrating a processor, as depicted in FIG. 1, in accordance with a further embodiment of the present invention.

FIGS. 3A and 3B depict block diagrams illustrating 128-bit packed SIMD data types, in accordance with one embodiment of the present invention.

FIGS. 3C and 3D depict block diagrams illustrating 64-bit packed SIMD data types, in accordance with a further embodiment of the present invention.

FIG. 4 depicts a block diagram illustrating unit-stride, SIMD vectorization of a unit-stride, serial code loop, in accordance with one embodiment of the present invention.

FIG. 5 depicts a block diagram illustrating a scalar implementation of a non-unit stride serial code loop, in accordance with conventional compiler techniques.

FIG. 6 depicts a block diagram illustrating adjacent, stride-2 vectorization of a detected adjacent, stride-2 load access pattern within a serial code loop, in accordance with one embodiment of the present invention.

FIG. 7 depicts a block diagram illustrating SIMD vectorization of serial code collectively performing adjacent, stride-2 load access patterns within a serial code loop, in accordance with a further embodiment of the present invention.

FIG. 8 depicts a block diagram illustrating SIMD vectorization of serial code collectively performing adjacent, stride-2 store access patterns within a detected serial code loop, in accordance with a further embodiment of the present invention.

FIG. 9 depicts a block diagram illustrating SIMD vectorization of serial code statements collectively performing K-adjacent, non-unit stride load access patterns within a detected serial code loop, in accordance with a further embodiment of the present invention.

FIG. 10 depicts a block diagram illustrating SIMD vectorization of serial code collectively performing K-adjacent, non-unit stride store access pattern within a detected serial code loop, in accordance with a further embodiment of the present invention.

FIG. 11 depicts a flowchart illustrating a method for vectorizing serial code statements collectively performing adjacent, non-unit stride memory access within a detected serial code loop, utilizing SIMD instructions, in accordance with one embodiment of the present invention.

FIG. 12 depicts a flowchart illustrating an additional method for analyzing a source program to detect serial code statements collectively performing adjacent, non-unit stride memory access, in accordance with a further embodiment of the present invention.

FIG. 13 depicts a flowchart illustrating an additional method for analyzing a source program to detect serial code statements collectively performing adjacent, non-unit stride memory access, in accordance with the further embodiment of the present invention.

FIG. 14 depicts a flowchart illustrating an additional method for analyzing a source program to detect serial code statements collectively performing adjacent, non-unit stride memory access, in accordance with a further embodiment of the present invention.

FIG. 15 depicts a flowchart illustrating an additional method for vectorizing serial code statements collectively performing adjacent, non-unit stride memory access, in accordance with the further embodiment of the present invention.

FIG. 16 depicts a flowchart illustrating an additional method for generating vector code statements to perform the adjacent, non-unit stride memory access of detected serial code statements, in accordance with a further embodiment of the present invention.

FIG. 17 depicts a flowchart illustrating an additional method for generating SIMD instructions to load adjacent memory elements, in accordance with a further embodiment of the present invention.

FIG. 18 depicts a flowchart illustrating an additional method for generating vector code statements to perform adjacent, non-unit stride memory access of one or more detected serial code statements, in accordance with a further embodiment of the present invention.

FIG. 19 depicts a flowchart illustrating an additional method for generating SIMD instructions to reorder data elements to enable adjacent, stride-2 memory access patterns performed by one or more detected serial code statements, in accordance with a further embodiment of the present invention.

FIG. 20 depicts a flowchart illustrating an additional method for generating a target executable program from an optimized internal representation of a received source program utilizing SIMD code statements to perform the collective adjacent, non-unit stride memory access, utilizing SIMD instructions, in accordance with an exemplary embodiment of the present invention.

### DETAILED DESCRIPTION

A method and apparatus for implementing adjacent, non-unit stride memory access patterns utilizing SIMD instructions are described. In one embodiment, the method includes compiler analysis of a source program to detect vectorizable loops having serial code statements that collectively perform adjacent, non-unit stride memory access. Once a vectorizable loop containing code statements that collectively perform adjacent, non-unit stride memory access in detected, the system compiler vectorizes the serial code statements of the detected loop to perform the adjacent, non-unit stride memory access utilizing SIMD instructions. As such, the compiler repeats the analysis and vectorization for each vectorizable loop within the source program code.

In the following description, for the purposes of explanation, numerous specific details are set forth in order to provide a thorough understanding of the embodiments of the present invention. It will be apparent, however, to one skilled in the art that the various embodiments of the present invention may be practiced without some of these specific details. In addition, the following description provides examples, and the accompanying drawings show various examples for the purposes of illustration. However, these examples should not be construed in a limiting sense as they are merely intended to provide examples of the embodiments of the present invention rather than to provide an exhaustive list of all possible implementations of the embodiments of the present invention. In other instances, well-known structures and devices are shown in block diagram form in order to avoid obscuring the details of the various embodiments of the present invention.

Portions of the following detailed description may be presented in terms of algorithms and symbolic representations of operations on data bits. These algorithmic descriptions and representations are used by those skilled in the data processing arts to convey the substance of their work to others skilled in the art. An algorithm, as described herein, refers to a self-consistent sequence of acts leading to a desired result. The acts are those requiring physical manipulations of physical quantities. These quantities may take the form of electrical or magnetic signals capable of being stored, transferred, combined, compared, and otherwise manipulated. Moreover, principally for reasons of common usage, these signals are referred to as bits, values, elements, symbols, characters, terms, numbers, or the like.

However, these and similar terms are to be associated with the appropriate physical quantities and are merely convenient labels applied to these quantities. Unless specifically stated otherwise, it is appreciated that discussions utilizing terms such as “processing” or “computing” or “calculating” or “determining” or displaying” or the like, refer to the action and processes of a computer system, or similar electronic computing device, that manipulates and transforms data represented as physical (electronic) quantities within the computer system's devices into other data similarly represented as physical quantities within the computer system devices such as memories, registers or other such information storage, transmission, display devices, or the like.

The algorithms and displays presented herein are not inherently related to any particular computer or other apparatus. Various general purpose systems may be used with programs in accordance with the teachings herein, or it may prove convenient to construct more specialized apparatus to perform the required method. For example, any of the methods according to the various embodiments of the present invention can be implemented in hard-wired circuitry, by programming a general-purpose processor, or by any combination of hardware and software.

One of skill in the art will immediately appreciate that the invention can be practiced with computer system configurations other than those described below, including hand-held devices, multiprocessor systems, microprocessor-based or programmable consumer electronics, digital signal processing (DSP) devices, network PCs, minicomputers, mainframe computers, and the like. The invention can also be practiced in distributed computing environments where tasks are performed by remote processing devices that are linked through a communications network. The required structure for a variety of these systems will appear from the description below.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression.

Thus, one skilled in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the embodiments of the present invention may be practiced as well as implemented as an embodiment).

In an embodiment, the methods of the various embodiments of the present invention are embodied in machine-executable instructions. The instructions can be used to cause a general-purpose or special-purpose processor that is programmed with the instructions to perform the methods of the embodiments of the present invention. Alternatively, the methods of the embodiments of the present invention might be performed by specific hardware components that contain hardwired logic for performing the methods, or by any combination of programmed computer components and custom hardware components.

In one embodiment, the present invention may be provided as a computer program product which may include a machine or computer-readable medium having stored thereon instructions which may be used to program a computer (or other electronic devices) to perform a process according to one embodiment of the present invention. The computer-readable medium may include, but is not limited to, floppy diskettes, optical disks, Compact Disc, Read-Only Memory (CD-ROMs), and magneto-optical disks, Read-Only Memory (ROMs), Random Access Memory (RAMs), Erasable Programmable Read-Only Memory (EPROMs), Electrically Erasable Programmable Read-Only Memory (EEPROMs), magnetic or optical cards, flash memory, or the like.

Accordingly, the computer-readable medium includes any type of media/machine-readable medium suitable for storing electronic instructions. Moreover, one embodiment of the present invention may also be downloaded as a computer program product. As such, the program may be transferred from a remote computer (e.g., a server) to a requesting computer (e.g., a client). The transfer of the program may be by way of data signals embodied in a carrier wave or other propagation medium via a communication link (e.g., a modem, network connection or the like).

Computing Architecture

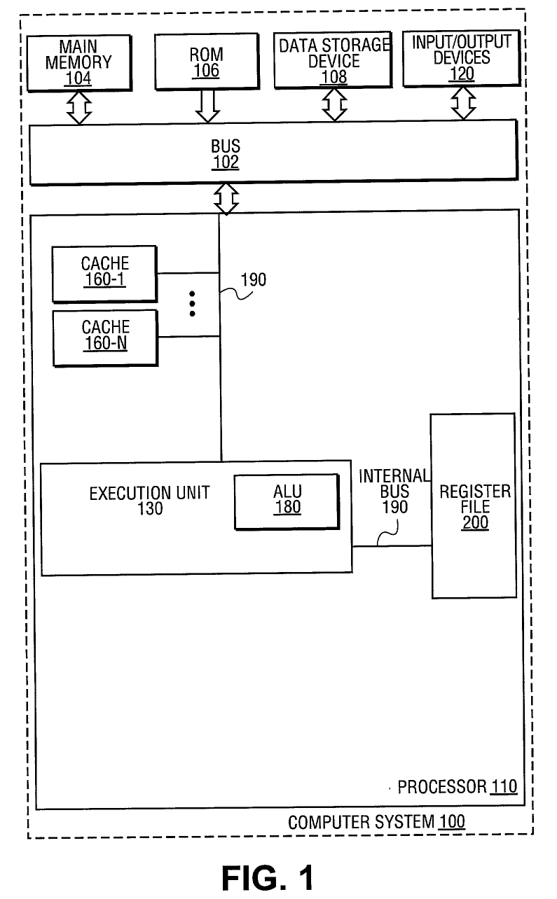

FIG. 1 shows a computer system 100 upon which one embodiment of the present invention can be implemented. Computer system 100 comprises a bus 102 for communicating information, and processor 110 coupled to bus 102 for processing information. The computer system 100 also includes a memory subsystem 104-108 coupled to bus 102 for storing information and instructions for processor 110. Processor 110 includes an execution unit 130 containing an arithmetic logic unit (ALU) 180, a register file 200 and one or more cache memories 160 (160-1, . . . , 160-N).

High speed, temporary memory buffers (cache) 160 are coupled to execution unit 130 and store frequently and/or recently used information for processor 110. As described herein, memory buffers 160, include but are not limited to cache memories, solid state memories, RAM, synchronous RAM (SRAM), synchronous data RAM (SDRAM) or any device capable of supporting high speed buffering of data. Accordingly, high speed, temporary memory buffers 160 are referred to interchangeably as cache memories 160 or one or more memory buffers 160.

In one embodiment of the invention, register file 200 includes multimedia registers, for example, SIMD (single instruction, multiple data) registers for storing multimedia information. In one embodiment, multimedia registers each store up to one hundred twenty-eight bits of packed data. Multimedia registers may be dedicated multimedia registers or registers which are used for storing multimedia information and other information. In one embodiment, multimedia registers store multimedia data when performing multimedia operations and store floating point data when performing floating point operations.

In one embodiment, execution unit 130 operates on image/video data according to the instructions received by processor 110 that are included in instruction set 140. Execution unit 130 also operates on packed, floating-point and scalar data according to instructions implemented in general-purpose processors. Processor 110 as well as cache processor 400 are capable of supporting the Pentium® microprocessor instruction set as well as packed instructions, which operate on packed data. By including a packed instruction set in a standard microprocessor instruction set, such as the Pentium® microprocessor instruction set, packed data instructions can be easily incorporated into existing software (previously written for the standard microprocessor instruction set). Other standard instruction sets, such as the PowerPC™ and the Alpha™ processor instruction sets may also be used in accordance with the described invention. (Pentium® is a registered trademark of Intel Corporation. PowerPC™ is a trademark of IBM, APPLE COMPUTER and MOTOROLA. Alpha™ is a trademark of Digital Equipment Corporation.)

In one embodiment, the present invention provides adjacent, non-unit stride detection and vectorization operations with a system compiler. As described in further detail below, the various operations are utilized to detect one or more serial code statements that collectively perform adjacent, non-unit stride memory access within a vectorizable serial code loop. As described herein, a vectorizable serial code loop refers to a loop within a source program that contains serial instructions, for processing data in a serial manner, that can be replaced with vector instructions for processing serial data elements in parallel in order to improve the efficiency of the serial code loop. As such, in one embodiment, the system compiler initially detects each loop within a source program containing serial code instructions that will be replaced with vector code instructions, and identifies each detected loop as a vectorizable loop within an internal representation of the source program generated by the system compiler.

As such, in a further embodiment, the compiler analyzes each detected vectorizable serial code loop to determine whether one or more serial code statements within the detected loop that collectively performs adjacent, non-unit stride memory access. As known to those skilled in the art, a stride refers to a difference between two data addresses of successively loaded data within a source program. Accordingly, a unit-stride memory access pattern refers to a load/store program statement that selects/updates adjacent elements in memory.

However, many programs do not access data according to unit-stride access patterns. Accordingly, in one embodiment of the present invention, a compiler optimization is described, which is capable of detecting collective adjacent, non-unit stride memory access from serial code statements that access data according to non-unit stride memory access patterns. Consequently, when such serial code statements are detected, the compiler replaces the detected serial code statements with SIMD instruction code statements to perform the collective adjacent, non-unit stride memory access in parallel in order to provide improved program efficiency, which is referred to herein as SIMD vectorization.

Still referring to FIG. 1, the computer system 100 of the present invention may include one or more I/O (input/output) devices 120, including a display device such as a monitor. The I/O devices 120 may also include an input device such as a keyboard, and a cursor control such as a mouse, trackball, or trackpad. In addition, the I/O devices may also include a network connector such that computer system 100 is part of a local area network (LAN) or a wide area network (WAN), the I/O devices 120, a device for sound recording, and/or playback, such as an audio digitizer coupled to a microphone for recording voice input for speech recognition. The I/O devices 120 may also include a video digitizing device that can be used to capture video images, a hard copy device such as a printer, and a CD-ROM device.

Processor

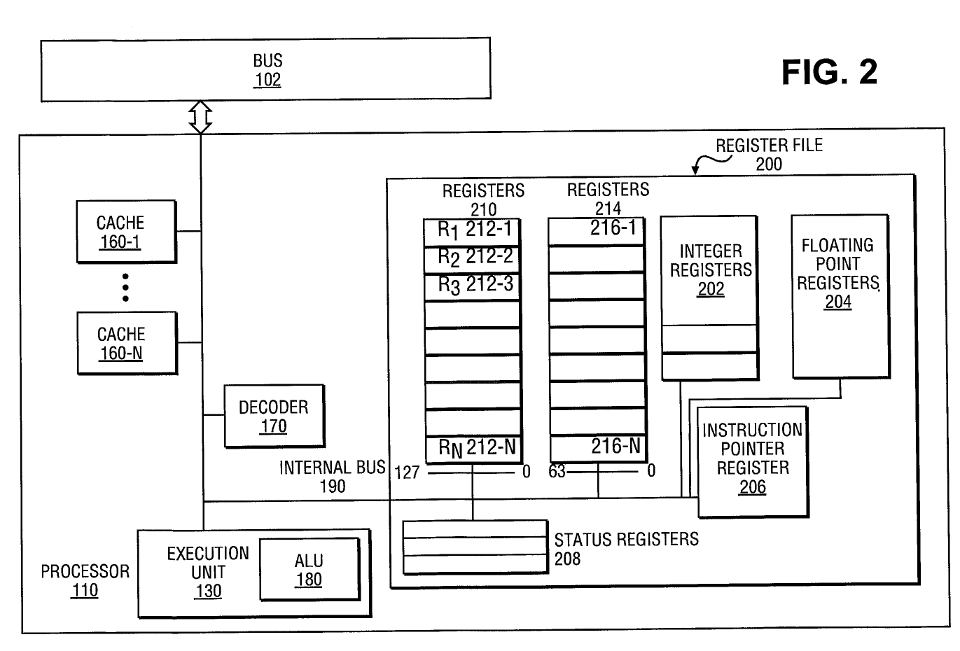

FIG. 2 illustrates a detailed diagram of processor 110. Processor 110 can be implemented on one or more substrates using any of a number of process technologies, such as, BiCMOS, CMOS, and NMOS. Processor 110 may include a decoder 170 for decoding control signals and data used by processor 110. Data can then be stored in register file 200 via internal bus 190. As a matter of clarity, the registers of an embodiment should not be limited in meaning to a particular type of circuit. Rather, a register of an embodiment need only be capable of storing and providing data, and performing the functions described herein.

Depending on the type of data, the data may be stored in integer registers 202, registers 210, registers 214, status registers 208, or instruction pointer register 206. Other registers can be included in the register file 204, for example, floating point registers 204. In one embodiment, integer registers 202 store thirty-two bit integer data. In one embodiment, registers 210 contains eight multimedia registers, R₀ 212-1 through R₇ 212-7, for example, single instruction, multiple data (SIMD) registers containing packed data. In one embodiment, each register in registers 210 is one hundred twenty-eight bits in length. R₁ 212-1, R₂ 212-2 and R₃ 212-3 are examples of individual registers in registers 210. Thirty-two bits of a register in registers 210 can be moved into an integer register in integer registers 202. Similarly, values in an integer register can be moved into thirty-two bits of a register in registers 210.

In one embodiment, registers 214 contains eight multimedia registers, 216-1 through 216-N, for example, single instruction, multiple data (SIMD) registers containing packed data. In one embodiment, each register in registers 214 is sixty-four bits in length. Thirty-two bits of a register in registers 214 can be moved into an integer register in integer registers 202. Similarly, values in an integer register can be moved into thirty-two bits of a register in registers 214. Status registers 208 indicate the status of processor 110. In one embodiment, instruction pointer register 211 stores the address of the next instruction to be executed. Integer registers 202, registers 210, status registers 208, registers 214, floating-point registers 204 and instruction pointer register 206 all connect to internal bus 190. Any additional registers would also connect to the internal bus 190.

In another embodiment, some of these registers can be used for different types of data. For example, registers 210/214 and integer registers 202 can be combined where each register can store either integer data or packed data. In another embodiment, registers 210/214 can be used as floating point registers. In this embodiment, packed data or floating point data can be stored in registers 210/214. In one embodiment, the combined registers are one hundred ninety-two bits in length and integers are represented as one hundred ninety-two bits. In this embodiment, in storing packed data and integer data, the registers do not need to differentiate between the two data types.

Execution unit 130, in conjunction with, for example ALU 180, performs the operations carried out by processor 110. Such operations may include shifts, addition, subtraction and multiplication, etc. Functional unit 130 connects to internal bus 190. In one embodiment, the processor 110 includes one or more memory buffers (cache) 160. The one or more cache memories 160 can be used to buffer data and/or control signals from, for example, main memory 104. In one embodiment, the cache memories 160 are connected to decoder 170 to receive control signals.

Data and Storage Formats

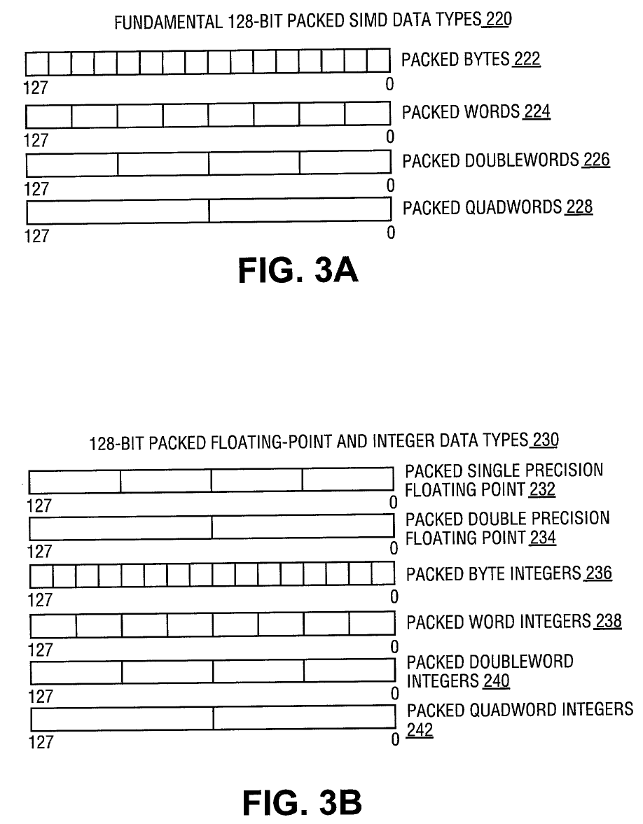

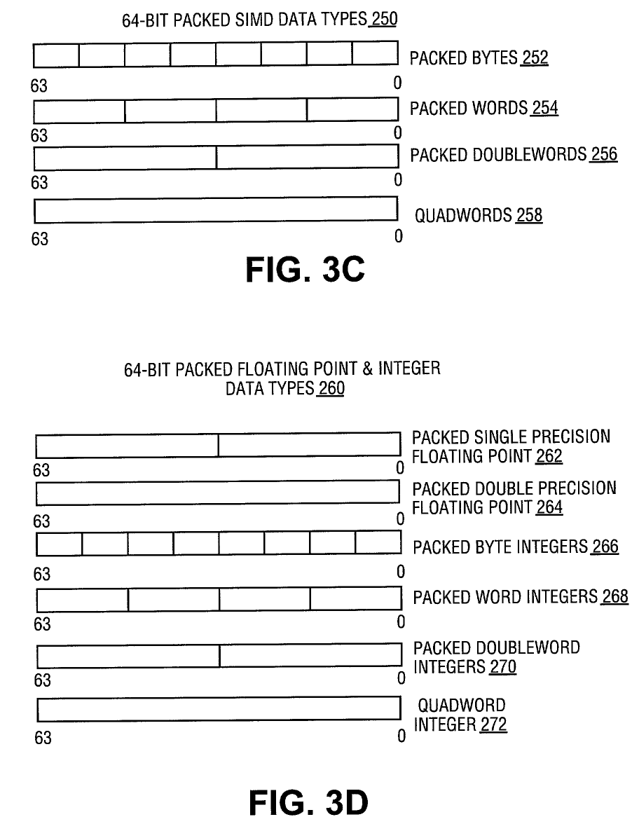

Referring now to FIGS. 3A and 3B, FIGS. 3A and 3B illustrate 128-bit SIMD data type according to one embodiment of the present invention. FIG. 3A illustrates four 128-bit packed data-types 220, packed byte 222, packed word 224, packed doubleword (dword) 226 and packed quadword 228. Packed byte 222 is one hundred twenty-eight bits long containing sixteen packed byte data elements. Generally, a data element is an individual piece of data that is stored in a single register (or memory location) with other data elements of the same length. In packed data sequences, the number of data elements stored in a register is one hundred twenty-eight bits divided by the length in bits of a data element.

Packed word 224 is one hundred twenty-eight bits long and contains eight packed word data elements. Each packed word contains sixteen bits of information. Packed doubleword 226 is one hundred twenty-eight bits long and contains four packed doubleword data elements. Each packed doubleword data element contains thirty-two bits of information. A packed quadword 228 is one hundred twenty-eight bits long and contains two packed quad-word data elements. Thus, all available bits are used in the register. This storage arrangement increases the storage efficiency of the processor. Moreover, with multiple data elements accessed simultaneously, one operation can now be performed on multiple data elements simultaneously.

FIG. 3B illustrates 128-bit packed floating-point and Integer Data types 230 according to one embodiment of the invention. Packed single precision floating-point 232 illustrates the storage of four 32-bit floating point values in one of the SIMD registers 210, as shown in FIG. 2. Packed double precision floating-point 234 illustrates the storage of two 64-bit floating-point values in one of the SIMD registers 210 as depicted in FIG. 2. As described in further detail below, packed double precision floating-point 234 may be utilized to store an entire sub-matrix, utilizing two 128-bit registers, each containing four vector elements which are stored in packed double precision floating-point format. Packed byte integers 236 illustrate the storage of 16 packed integers, while packed word integers 238 illustrate the storage of 8 packed words. Finally, packed doubleword integers 240 illustrate the storage of four packed doublewords, while packed quadword integers 242 illustrate the storage of two packed quadword integers within a 128-bit register, for example as depicted in FIG. 2.

Referring now to FIGS. 3C and 3D, FIGS. 3C and 3D depict blocked diagrams illustrating 64-bit packed single instruction multiple data (SIMD) data types, as stored within registers 214, in accordance with one embodiment of the present invention. As such, FIG. 3C depicts four 64-bit packed data types 250, packed byte 252, packed word 254, packed doubleword 256 and quadword 258. Packed byte 252 is 64 bits long, containing 8 packed byte data elements. As described above, in packed data sequences, the number of data elements stored in a register is 64 bits divided by the length in bits of a data element. Packed word 254 is 64 bits long and contains 4 packed word elements. Each packed word contains 16 bits of information. Packed doubleword 256 is 64 bits long and contains 2 packed doubleword data elements. Each packed doubleword data element contains 32 bits of information. Finally, quadword 258 is 64 bits long and contains exactly one 64-bit packed quadword data element.

Referring now to FIG. 3D, FIG. 3D illustrates 64-bit packed floating-point and integer data types 260, as stored within registers 214, in accordance with a further embodiment of the present invention. Packed single precision floating point 262 illustrates the storage of two 32-bit floating-pint values in one of the SIMD registers 214 as depicted in FIG. 2. Packed double precision floating-point 264 illustrates the storage of one 64-bit floating point value in one of the SIMD registers 214 as depicted in FIG. 2. Packed byte integer 266 illustrates the storage of eight 32-bit integer values in one of the SIMD registers 214 as depicted in FIG. 2. Packed doubleword integer 270 illustrates the storage of two 32-bit integer values in one of the SIMD registers 214 as depicted in FIG. 2. Finally, quadword integer 272 illustrates the storage of a 64-bit integer value in one of the SIMD registers 214 as depicted in FIG. 2.

Non-Unit Stride SIMD Vectorization

As described above, vectorization of serial code provides a significant enhancement to execution bandwidth in mainstream computing. Using this approach, multiple functional units operate simultaneously on so-called packed data elements (relatively short vectors that reside in memory or registers) (see FIGS. 3A-3D). As a result, since a single instruction processes multiple data elements in parallel, this form of instruction level parallelism provides a new way to utilize data parallelism first devised during the early days of supercomputers. Accordingly, recent extensions to computing architectures implement vectorization to enhance performance of computationally intensive applications.

Unfortunately, much of the code that exploits these recent vector codes, such as SIMD extensions, must be hand-coded by a programmer. Moreover, in order to benefit from the vectorization utilized in current architectural advancements, legacy code must be rewritten in order to utilize the vector architectural advances provided. Accordingly, in one embodiment, the system compiler automatically converts detected serial code into an SIMD form by compiler conversion of serial code into an SIMD format, which is referred to herein as “SIMD vectorization”.

However, in contrast to current compiler vectorization techniques, the system compiler described by one embodiment of the present invention is not limited to vectorization of serial code load/store operations within program loops that exhibit regular (unit-stride) memory access patterns. Moreover, legacy vectorization compilers are unable to vectorize non-unit stride memory access for architectures that support streaming SIMD extension (SEE/SSE2) for processing single and double precision floating point, as well as packed integer data elements (see FIGS. 3A-3D). As described herein, the term “current vectorization compilers” refers to compilers for architectures that support SSE/SSE2 extensions, such as SIMD extension architectures described above.

In contrast, the term “legacy vectorizing compilers” refers to compilers for legacy vector architectures described above. As a result, when current vectorization compilers encounter non-unit stride memory references, the current compilers resort to implementing of the detected loop using either scalar instructions, or vector code including scalar shuffle/unpack instructions for implementing the non-unit stride memory references. As recognized by those skilled in the art, the use of scalar instructions to perform non-unit stride memory access does not provide any of the benefits realized from SIMD vectorization as utilized by the system compiler within the embodiments of the present invention.

TABLE 1

DO

i = 1, N
A[i] = B[i] + C[i]

ENDDO

### UNIT-STRIDE CODE LOOP

TABLE 2

| Vector Loop | | | |
|---|---|---|---|
| | mov | eax, | 0 |
| Loop 1: | | | |

| movaps | xmm0, [@B+eax] | | |
|---|---|---|---|
| movaps | xmm1, [@C+eax] | | |
| paddps | xmm0, xmm1 | | |
| movaps | [@A+eax], xmm0 | | |
| add | eax, 16 | | |
| . . . | | | |
| jle | Loop 1 | ; | looping logic |

### SIMD VECTOR CODE

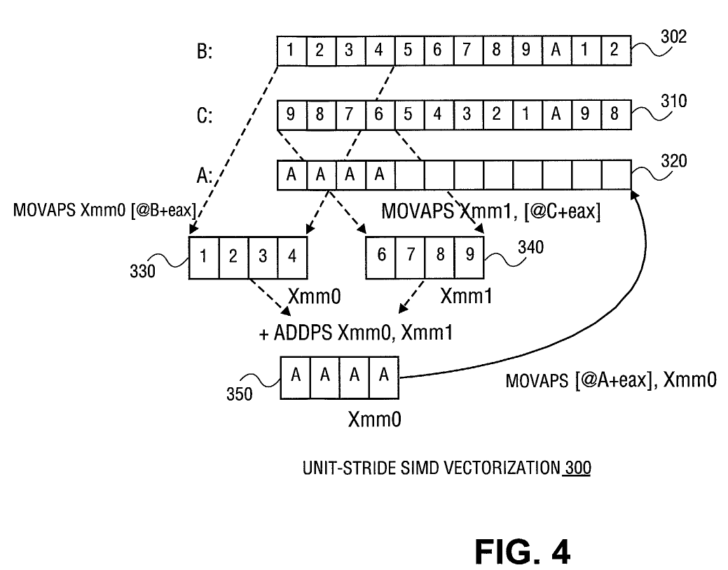

Referring now to Table 1, Table 1 describes a serial code loop that exhibits a unit-stride load access pattern. In other words, the data access performed within the serial code loop of Table 1 accesses, for example, adjacent floating point elements in memory (array B[i] and C[i]). Consequently, as depicted with reference to Table 2, the serial code loop can be vectorized in order to generate the SIMD vectorization code, as depicted in Table 2. The functionality of the SIMD vectorization code depicted in Table 2 is illustrated with reference to FIG. 4. As illustrated with reference to Tables 1-14, single precision floating point data elements are accessed. However, those skilled in the art will recognize that the SIMD vectorization, described within embodiments of the present invention, is not limited to floating point data elements and includes packed data elements provided in Tables 3A-3D and the like.

Referring now to FIG. 4, FIG. 4 depicts a block diagram illustrating unit-stride SIMD vectorization 300. As illustrated, array B[i] 302 is depicted containing various memory elements. In addition, array C[i] 310 is also illustrated with its respective data elements. Consequently, a vectorization compiler, in response to detection of serial code depicted in Table 1, would generate the following SIMD vector (assembly) code as depicted in Table 2.

As illustrated with reference to FIG. 4, a packed move instruction (MOVAPS) is an SIMD instruction that loads four consecutive floating point memory elements into a register. As such, the MOVAPS instructions load four consecutive data elements from array B[i] 302 into register 330 (XMM0). In addition, four consecutive floating point elements are loaded from array C[i] 310 into a second register 340 (XMM1). Once loaded, an SIMD, packed floating point (FP) add instruction (PADDD) adds the respective data elements within XMM0 330 and XMM1 340, with the result stored in register XMM0 340. Once generated, the result is copied to the destination array A[i] 320. Accordingly, the serial code loop depicted in Table 1 can be vectorized in order to generate SIMD vector code listed in Table 2.

TABLE 3

| | |
|---|---|
| DO | i = 1, N, 5 |
| | A[i] = B[i] + C[i] |
| ENDD | |

### NON-UNIT STRIDE SERIAL CODE LOOP

TABLE 4

| | | | |
|---|---|---|---|
| | mov | ebx, | 0 |
| Loop 1: | | | |

| mov | eax, [@B+ebx] | | |
|---|---|---|---|
| Fadd | eax, [@C+ebx] | | |
| mov | [@A+ebx], eax | | |
| mov | eax, 0 | | |
| add | ebx, 5 | | |
| . . . | | | |
| jle | Loop 1 | ; | looping logic |

### SCALAR ASSEMBLY CODE

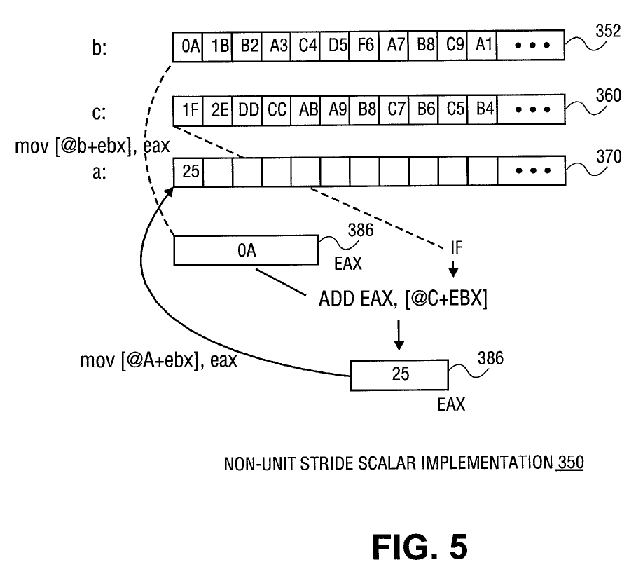

Referring now to Table 3, Table 3 depicts pseudo-code of a serial code loop that performs a non-unit stride load access pattern. Accordingly, a current vectorization compiler would determine that non-unit stride serial code loop depicted in Table 3 cannot be converted (vectorized) into SIMD instructions for parallel computation of the addition operation performed within the serial code loop. Consequently, as depicted with reference to Table 4, a conventional compiler would generate scalar, assembly code to perform the operations of the serial code loop depicted in Table 3. In other words, as illustrated with reference to FIG. 5, the scalar assembly code sequentially adds the various elements within array B[i] 352 and array C[i] 360, with the result placed within array A[i] 370. Accordingly, as illustrated with reference to FIG. 5, a current vectorization compiler is incapable of providing performance enhancing vectorization to serial code loops which exhibit non-unit stride memory access patterns.

TABLE 5

Serial Code Loop
REAL A[2*N] // assume 16-byte aligned
. . .
DO I + 1, N

. . . = . . . A[2*I−1] . . .
. . . = . . . A[2*I] . . .

ENDO

### ADJACENT, STRIDE-2 LOAD ACCESS PATTERN

TABLE 6

| | | | | |
|---|---|---|---|---|
| | mov | eax, | @A | |
| Loop 1: | movaps | xmm0, | [eax] | ; xmm0 = \|a4\|a3\|a2\|a1\| |
| | movaps | xmm2, | [eax+16] | ; xmm2 = \|a8\|a7\|a6\|a5\| |
| | movaps | xmm1, | xmm0 | |
| | shufps | xmm0, | xmm2, 136 | ; xmm0 = \|a7\|a5\|a3\|a1\| |
| | shufps | xmm1, | xmm2, 221 | ; xmm1 = \|a8\|a6\|a4\|a2\| |
| | add eax, 32 | | | |
| | . . . | | | |
| | jle Loop1 | | | ; looping logic |

### SSE INSTRUCTION SEQUENCE FOR LOADS

Referring now to Table 5, Table 5 depicts a serial code loop containing consecutive, data load operations that perform non-unit stride load access patterns. As a result, a current vectorization compiler would analyze the serial code loop illustrated in Table 5 and determine that non-unit stride memory access is performed. Accordingly, the current vectorization compiler would forego generation of vector code to perform the non-unit stride load access patterns of serial code loop illustrated in Table 5. However, the data load operations of the serial code loop in Table 5 perform a stride-2 load access pattern.

As described herein, a stride-2 load access pattern refers to access patterns that have a stride equal to two (=2). Although the pattern of the data accessed by each load operation in Table 5 essentially skips every other data element, the load operations collectively access adjacent elements in memory (unit-stride memory access). Consequently, in one embodiment of the present invention, the system compiler includes functionality to detect serial code statements within a unit vectorizable loop that collectively perform unit-stride memory access, which is referred to herein as “adjacent, non-unit stride memory access”.

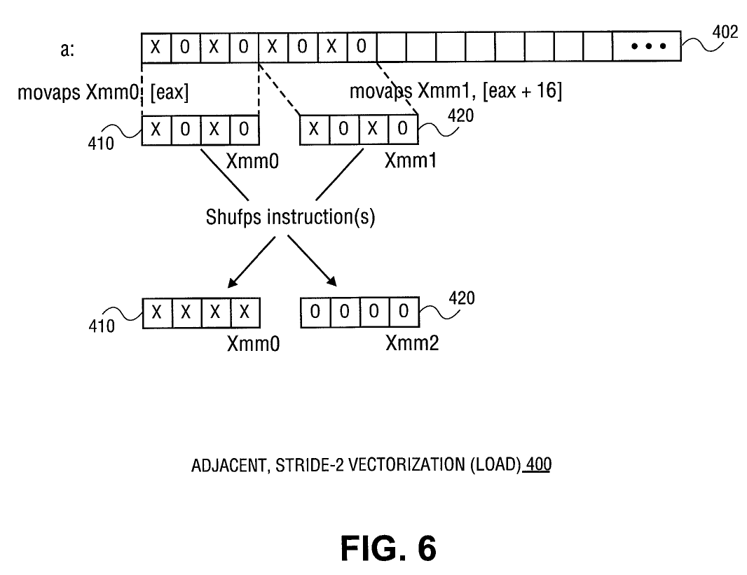

Accordingly, utilizing embodiments of the present invention, in one embodiment, the system compiler would detect that the serial code loop depicted in Table 5 contains serial code statements that collectively perform adjacent, non-unit stride memory access (“collective unit-stride memory access”). As illustrated by the SIMD vectorization code depicted in Table 6, vector code (SIMD instruction statements) may be generated for the serial code loop depicted in Table 5. Generation of the SIMD assembly code (Table 6) is further described with reference to FIG. 6.

As illustrated in FIG. 6, a MOVAPS instruction loads four floating point data elements within register (XMM0) 410. In addition, a MOVAPS instruction loads a next, four consecutive elements within a second register (XMM1) 420. Once loaded, an SIMD shuffle instruction (SHUFPS) can be used to shuffle the various data elements within registers XMM0 and XMM1, such that XMM0 will contain stride-2 data elements accessed by the first serial code load statement of the serial code loop listed in Table 5. In addition, register XMM2 contains stride-2 memory elements accessed by a second serial code load statement, as illustrated in Table 5. Consequently, utilizing the system compiler described by one embodiment of the present invention, vectorization of serial code statements that perform non-unit stride memory access is possible for adjacent, stride-2 load access patterns.

TABLE 7

Serial Code Loop
REAL A[2*N]// assume 16-byte aligned
. . .
DO I = 1, N

A [2*I−1] = . . .
A [2*I] = . . .

ENDO

### ADJACENT, NON-UNIT STRIDE STORE ACCESS PATTERN

Referring now to Table 7, Table 7 depicts an additional serial code loop which performs non-unit stride store access patterns. Consequently, when such a serial code loop is detected by a current vectorization compiler, the current vectorization compiler will forego vectorization of the serial code load statements due to the non-unit stride store access pattern exhibited by the serial code statements. However, in contrast to current vectorization compilers, in one embodiment, the system compiler of the present invention can detect that the serial code statements perform adjacent stride-2 store access patterns.

TABLE 8

| | | | | |
|---|---|---|---|---|
| mov | | eax, @A | | |
| Loop2: | . . . | | | |
| | | | | ; xmm0 = \|a7\|a5\|a3\|a1\| |
| | | | | ; xmm2 = \|a8\|a6\|a4\|a2\| |
| | movaps | xmm1, | xmm0 | |
| | unpcklps | xmm0, | xmm2 | ; xmm0 = \|a4\|a3\|a2\|a1\| |
| | unpckhps | xmm1, | xmm2 | ; xmm1 = \|a8\|a7\|a6\|a5\| |
| | movaps | [eax], | xmm0 | |
| | movaps | [eax+16], | xmm1 | |
| | add eax, | 32 | | |
| | . . . | | | |
| | jle Loop2 | | | ; looping logic |

### SIMD VECTOR CODE

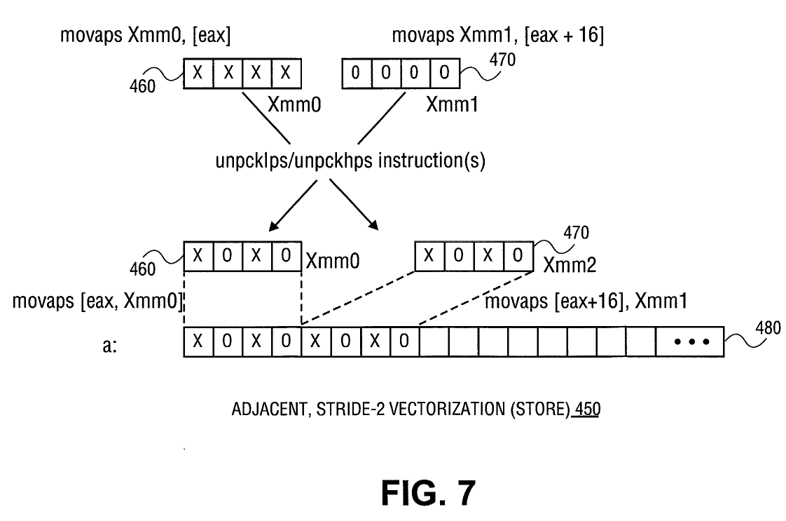

Accordingly, as illustrated by the SIMD vector code depicted in Table 8, the system compiler of the present invention generates the code listed in Table 8 when detecting one or more serial code statements that collectively perform adjacent stride-2 store access patterns. For example, as illustrated with reference to FIG. 7, the first register (XMM0) 460 will contain stride-2 data elements accessed by the first serial code load statement. In addition, a second register (XMM1) will contain stride-2 data elements accessed by a second serial code load statement. Accordingly, utilizing SIMD unpack instructions (UNPCKLPS/UNPCKHPS), data within register XMM0 and XMM1 may be unpacked, such that register 460 and register 470 now contain the adjacent memory elements of array A[i] 480. Consequently, utilizing MOVAPS instructions, the contents of registers 460 and 470 can be stored within register A in order to complete vectorization of serial code, as depicted in Table 7.

TABLE 9

| Serial Code Loop | |
|---|---|
| REAL A[2*N] | // ASSUME 16-BYTE ALIGNED |
| . . . | |
| DO I + 1, N | |

. . . = . . . A[3*I−1] . . .
. . . = . . . A[3*I−1] . . .
. . . = . . . A[3*I] . . .

ENDO

### K-ADJACENT, NON-UNIT STRIDE LOAD ACCESS PATTERN

Although the adjacent, non-unit stride memory access pattern, as depicted with reference to FIGS. 6 and 7 refer to stride-2 memory access patterns, the system compiler described within the embodiments of the present invention, is capable of vectorizing serial code statements that collectively perform K-adjacent, non-unit stride load access pattern. As illustrated with reference to serial code loop provided in Table 9, the standard vectorization compiler would forego vectorization of the serial code statement.

TABLE 10

| | | | |
|---|---|---|---|
| | mov eax, @A | | |
| Loop: | movaps xmm0, | [eax] | \|a4 a3 a2 a1\| |
| | movaps xmm1, | [eax+16] | \|a8 a7 a6 a5\| |
| | movaps xmm2, | [eax+32] | \|a12 a11 a10 a9\| |
| | . . . shuffles . . . | | |
| | | | \|a10 a7 a4 a1\| |
| | | | \|a11 a8 a5 a2\| |
| | | | \|a12 a9 a6 a3\| |
| | add eax, 48 | | |
| | . . . | | |
| | jle Loop | | |

### SIMD VECTOR CODE (LOAD)

However, the system compiler of the present invention would detect that the plurality of serial code statements collectively perform K-adjacent, non-unit stride load access pattern. Consequently, the system compiler, according to an embodiment of the present invention, would generate the SIMD vector code, as depicted in Table 10, to perform the K-adjacent, non-unit stride load access pattern (K=3) required by the serial code statements of serial code loop, as illustrated in Table 9.

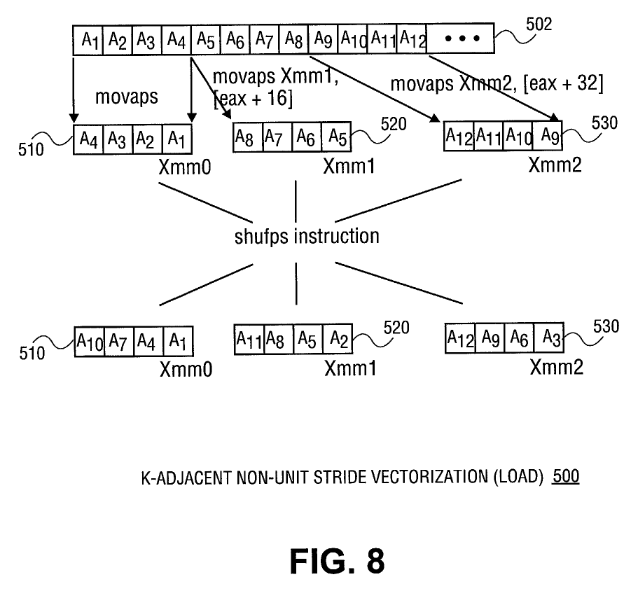

Referring to FIG. 8, FIG. 8 depicts array A 502 containing various adjacent data elements. According to the SIMD vector code provided in Table 10, MOVAPS instructions would load consecutive data elements within a first register (XMM0) 510, the second register (XMM1) 520 and a third register (XMM2) 530. Once the data is loaded, utilizing various shuffle instructions, the required data elements, according to the stride-3 access pattern required by serial code loop depicted in Table 9, the various elements would be contained within XMM0 register 510, XMM1 register 520 and XMM2 register 530.

TABLE 11

DO I = 1, N

| | |
|---|---|
| A(3*I−2) | = . . . |
| A(3*I−1) | = . . . |
| A(3*I) | = . . . |

ENDDO

TABLE 12

| mov eax, @A | | |
|---|---|---|
| Loop: | start with | \|a10 a7 a4 a1\| |
| | | \|a11 a8 a5 a2\| |
| | | \|a12 a9 a6 a3\| |

| | | |
|---|---|---|
| . . . shuffles . . . | | |
| movaps [eax], | ; xmm0 = | \|a4 a3 a2 a1\| |
| movaps [eax+16], | ; xmm1 = | \|a8 a7 a6 a5\| |
| movaps [eax+32], | ; xmm2 = | \|a12 a11 a10 a9\| |
| add eax eax, 48 | | |
| . . . | | |

| | | |
|---|---|---|
| jle Loop | ; | Looping Logic |

### SIMD VECTOR CODE (STORE)

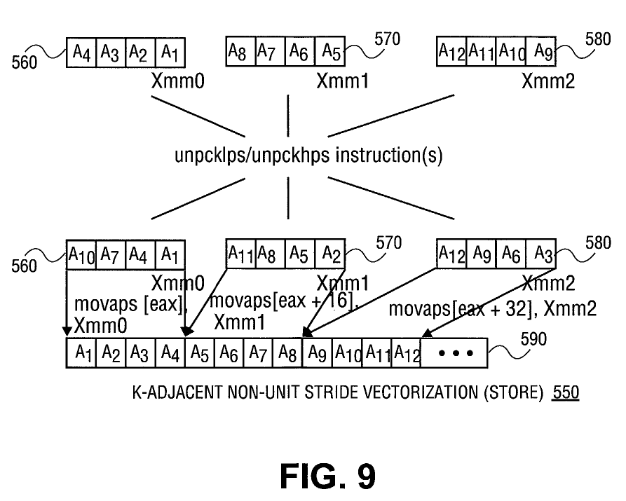

Referring now to Table 11, Table 11 lists serial code that exhibits K-adjacent, non-unit stride store access pattern (K=3). Based on code, as provided in Table 11, the system compiler, according to an embodiment of the present invention, would utilize SIMD unpack (unpcklps/unpckhps) instructions, as illustrated with reference to FIG. 9, in order to convert data within XMM0 register 560, XMM1 register 580 and XMM2 register 590, which contain data according to a stride-3 access pattern back to a unit-stride access pattern. Accordingly, following the SIMD unpack instructions to vectorize pseudo-code depicted in Table 11, XMM0 register 560, as well as registers 570 and 580, would contain unit-stride, adjacent data elements. Consequently, once the corresponding data is contained within the registers, MOVAPS instructions could write the adjacent data elements to array A[i] 590.

As illustrated with reference to Tables 9 and 11, the serial code loops depicted therein describe K-adjacent, non-unit stride load/store access patterns, where K=3. However, those skilled in the art will recognize that embodiments of the present invention may be expanded to K-adjacent, non-unit stride load/store access patterns, as depicted in Tables 13 and 14, respectively.

TABLE 13

DO I = 1, N

. . . = . . . A[K*I−(K−1)]
. . . = . . .
. . . = . . . A[K*I]

ENDO

### K-ADJACENT, NON-UNIT STRIDE LOAD ACCESS PATTERN

TABLE 14

DO I = 1, N

| | |
|---|---|
| A[K*I−(K−1)] | = . . . |
| . . . | = . . . |
| A[K*I] | = . . . |

ENDDO

### K-ADJACENT, NON-UNIT STRIDE STORE ACCESS PATTERN

However, the illustration of SIMD assembly code for processing of K-adjacent, non-unit stride load/store access patterns is omitted from the description of the embodiments of the present invention in order to avoid obscuring the details of the various embodiments described herein. Nonetheless, the ability to process K-adjacent, non-unit stride store/load access patterns simply results in an increased complexity in performing the corresponding shuffle/unpack instructions to reorder data elements within the desired stride order.

Accordingly, as illustrated with reference to FIGS. 4-9, one embodiment of the system compiler of the present invention increases the amount of vectorization performed when dealing with non-unit stride memory access patterns, as compared to current vectorization compilers. Moreover, the non-unit stride vectorization described drastically decreases the amount of serial code and scalar loops within a target program. As a result, compiled source programs will exhibit increased efficiency, as compared to conventional compiled programs. Procedural methods for implementing embodiments of the present invention are now described.

Operation

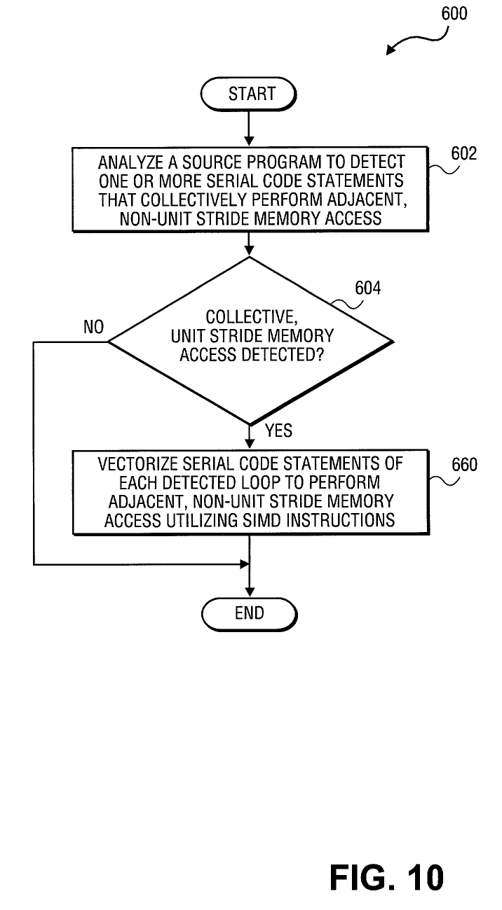

Referring now to FIG. 10, FIG. 10 depicts a flowchart illustrating a method for vectorizing one or more serial code statements that collectively perform adjacent, non-unit stride (unit stride) memory access within a system 100, for example, as depicted with reference to FIGS. 1-4. As described above, current vectorization compilers are unable to generate vector code statements for serial code statements that perform non-unit stride memory access (vectorize). As a result, one embodiment of the present invention further analyzes non-unit stride memory access serial code statements to determine whether successive serial code statements collectively access adjacent elements in memory.

As described herein, “collective performance of unit stride memory access” is interchangeably referred to herein as “adjacent, non-unit stride memory access” and “collective unit-stride memory access”. Consequently, by detecting collective unit-stride memory access performed by successive serial code statements, one embodiment of the system compiler described herein reduces the amount of serial code within a source program. As a result, the amount of SIMD vectorization performed during compilation of source programs is increased, resulting in target code with improved efficiency, as compared to target code generated by standard vectorization compilers.

Referring again to FIG. 10, at process block 602, a system compiler analyzes a source program to detect loops having one or more serial code statements that collectively perform adjacent, non-unit stride memory access. As described above, serial code statements that collectively access adjacent elements in memory can be vectorized utilizing embodiments of the present invention. In one embodiment, the source program is first analyzed to detect each vectorizable loop with the source program.

As described above, vectorizable loops refer to loops containing serial code statements that can be replaced with SIMD instruction statements to perform parallel processing of data elements. Accordingly, at process block 604, it is determined whether collective unit-stride memory access is detected while analyzing the source program. When the system compiler detects serial code statements that collectively perform unit-stride memory access, process block 660 is performed. At process block 660, the system compiler vectorizes serial code statements of each detected loop to perform adjacent, non-unit stride memory access, utilizing SIMD instructions (“SIMD vectorization”).

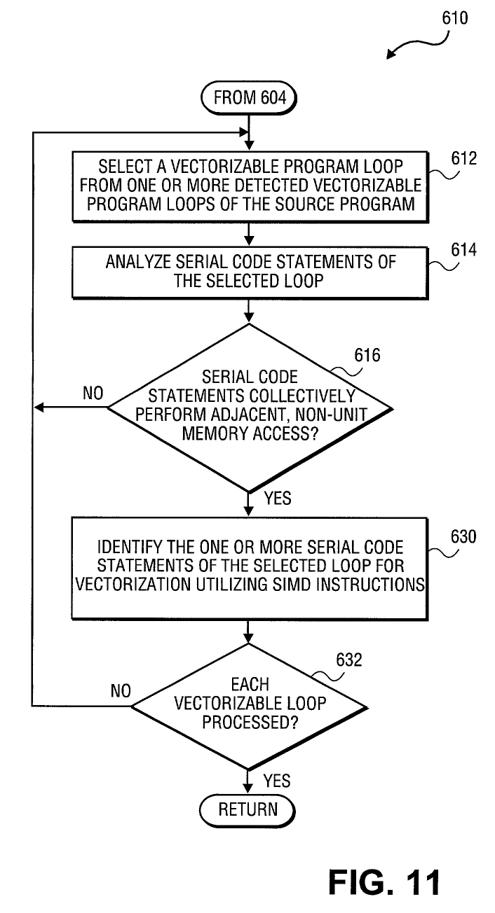

Referring now to FIG. 11, FIG. 11 depicts a flowchart illustrating an additional method 610 for analyzing a source program to detect collective unit-stride memory access of process block 604, as depicted in FIG. 10. At process block 612, the system compiler selects a vectorizable program loop from one or more detected vectorizable program loops of the source program. Once selected, at process block 614, serial code statements of the selected loop are analyzed to determine whether the statements collectively perform adjacent, non-unit stride memory access.

As a result, at process block 616, it is determined whether the serial code statements of the selected loop collectively perform unit-stride memory access. When collective unit stride memory access is detected, at process block 630, the serial code statements of the selected loop are identified for vectorization utilizing SIMD instructions. In one embodiment, the identification is performed within an internal representation generated from the source program code of the source program. Finally, at process block 632, process blocks 612-630 are repeated for each vectorizable loop of the source program.

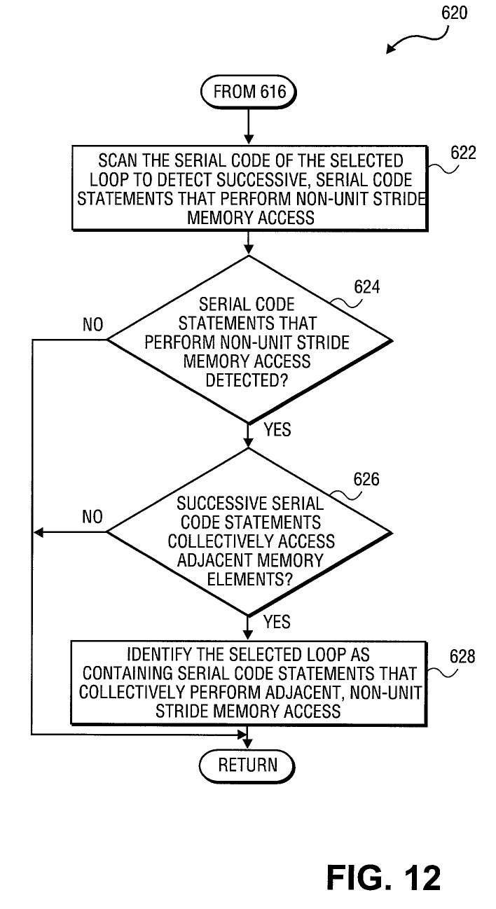

Referring now to FIG. 12, FIG. 12 depicts a flowchart illustrating an additional method 620 for detecting whether serial code statements collectively perform unit stride memory access of process block 616, as depicted in FIG. 11. At process block 622, serial code statements of the selected loop are scanned to detect successive serial code statements that perform non-unit stride memory access. Next, at process block 724, it is determined whether successive serial code statements that perform non-unit stride memory access are detected.

When such successive serial code statements are detected at process block 624, process block 626 is performed. At process block 626, it is determined whether the successive serial code statements collectively access adjacent memory elements. As described above, the collective access of adjacent memory elements is referred to herein interchangeably as adjacent, non-unit stride memory access. As such, when the successive serial code statements collectively access adjacent elements of memory, process block 628 is performed. At process block 628, the selected loop is identified as containing serial code statements that collectively perform adjacent, non-unit stride memory access.

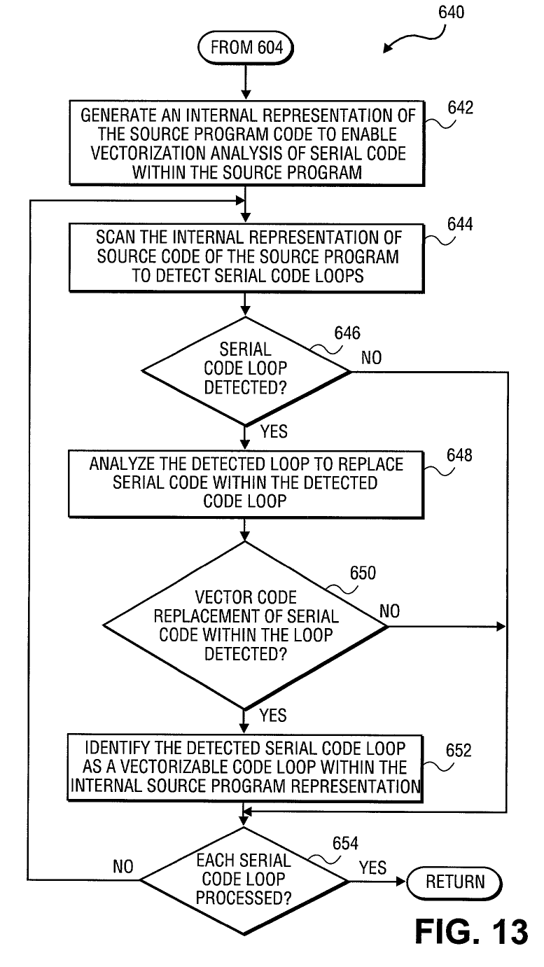

Referring now to FIG. 13, FIG. 13 depicts a flowchart illustrating an additional method 640 for determining whether one or more serial code statements collectively perform adjacent, non-unit stride memory access of process block 604, as depicted in FIG. 10. At process block 642, a system compiler generates an internal representation of the source program code to enable vectorization analysis of serial code within the source program. At process block 644, the system compiler scans the internal representation of the source code of the source program to detect serial code loops. Next, at process block 646, it is determined whether a serial code loop is detected. When a serial code loop is detected, process block 648 is performed. At process block 648, the system compiler analyzes the detected loop to determine whether vector code can be utilized to replace serial code within the detected code loop.

As described above, serial code loops that contain serial code statements that can be converted into vector code are referred to as “vectorizable serial code loops”. Accordingly, at process block 650, the system compiler determines whether vector code replacement of serial code within the load loop is possible. As such, when a vectorizable serial code loop is detected, process block 652 is performed. At process block 652, the system compiler identifies the detected serial code loop as a vectorizable serial code loop within the internal representation of the source program code. Finally, at process block 654, process blocks 644-652 are repeated for each serial code loop within the internal representation of the source program code.

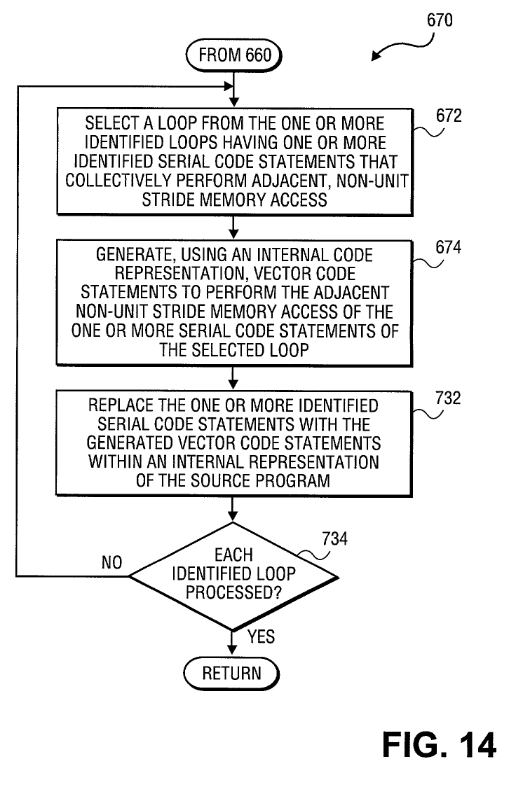

Referring now to FIG. 14, FIG. 14 depicts a flowchart illustrating an additional method 670 for vectorizing serial code statements of process block 660, as depicted in FIG. 10. At process block 672, the system compiler selects a loop from one or more identified loops having one or more serial code statements that collectively perform adjacent, non-unit stride memory access. As such, following identification of serial code statements that collectively perform adjacent, non-unit stride memory access of process block 628, process block 672 selects an identified loop. Once selected, at process block 674, the system compiler generates vector code statements to perform the adjacent, non-unit stride memory access of the one or more identified serial code statements of the selected loop.

In one embodiment, the vector code statements refer to SIMD instruction statements, which are represented in the intermediate code form utilized within an internal representation of the source program code. Once the vector code statements are generated, at process block 732, the system compiler replaces the one or more identified serial code statements with the generated vector code statements within an internal representation of the source program code. Finally, at process block 734, process blocks 672-732 are repeated for each identified load loop within the internal representation of the source program code.

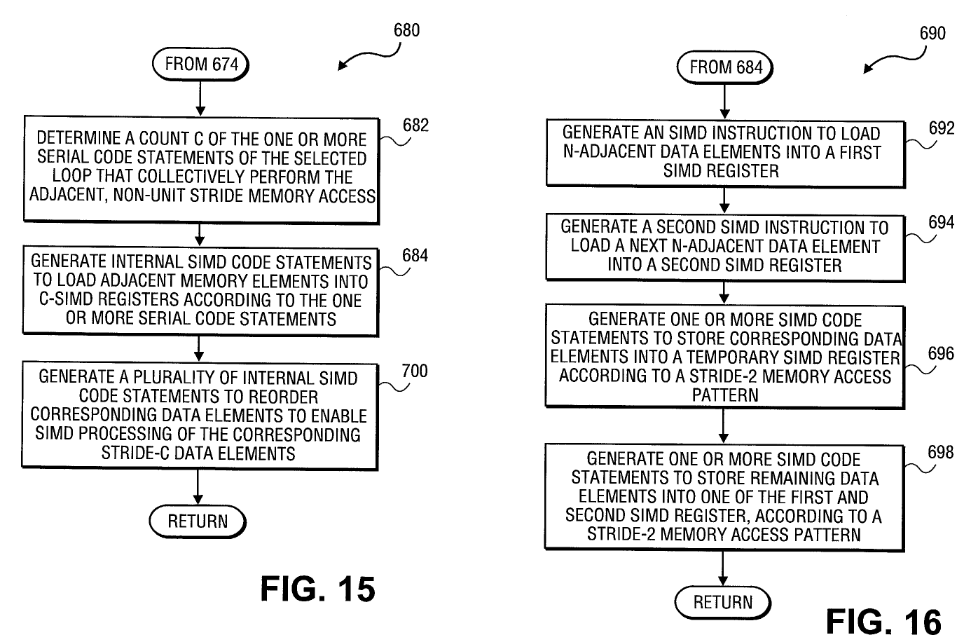

Referring now to FIG. 15, FIG. 15 depicts a flowchart illustrating an additional method 680 for generating vector code statements of process block 674, as depicted in FIG. 14. At process block 682, the system compiler determines a count (C) of the one or more identified serial code statements of the selected loop that collectively perform adjacent, non-unit stride memory access. Once the count is determined, at process block 684, the system compiler generates one or more internal SIMD code statements to load adjacent memory elements into C-SIMD registers according to the one or more serial code statements.

Finally, at process block 700, the system compiler generates a plurality of internal SIMD code statements to reorder corresponding data elements into a respective register according to a C-stride memory access pattern. In other words, data loaded within the plurality of SIMD registers is loaded into a respective register according to the C-stride memory access pattern in order to enable SIMD processing of the corresponding stride-C data elements.

For example, as depicted with reference to FIG. 6, data from array A[i] 402 is loaded into register 410 and register 420. Once loaded, a plurality of SIMD shuffle (SHUFPS) instructions are generated to place corresponding stride-2 data elements within a respective register. In other words, a first stride-2 memory element (X) is loaded into register XMM0 410. Likewise, a second stride-2 memory element (0) are loaded into register XMM2 420, utilizing the shuffle instruction. Consequently, the data within the corresponding registers (XMM0 and XMM2) may be processed according to the remaining statements of the serial code loop.

Referring now to FIG. 16, FIG. 16 depicts a flowchart illustrating an additional method 690 for generating SIMD instructions to load adjacent memory elements of process block 684, as depicted in FIG. 15. At process block 692, the system compiler generates an SIMD instruction statement to load K-adjacent data elements into a first SIMD register. Next, at process block 694, the system compiler generates a second SIMD instruction statement to load a next K-adjacent data elements into a second SIMD register. Once loaded, at process block 696, the system compiler generates one or more SIMD code statements to store corresponding data elements from the first and second SIMD registers into a temporary SIMD register.

For example, data elements from XMM0 register 410 and XMM1 register 420 are stored in XMM2 register 430, as depicted with reference to FIG. 6, according to a stride-2 memory access pattern. Finally, at process block 698, the system compiler generates one or more SIMD code statements to store remaining data elements from the first and second SIMD registers into one of the first and second SIMD registers according to a stride-2 memory access pattern. For example, as depicted with reference to FIG. 6, the first stride-2 data elements from array A are stored in XMM0 register 410. In addition, the subsequent stride-2 data elements (0) are stored in XMM2 register 420.

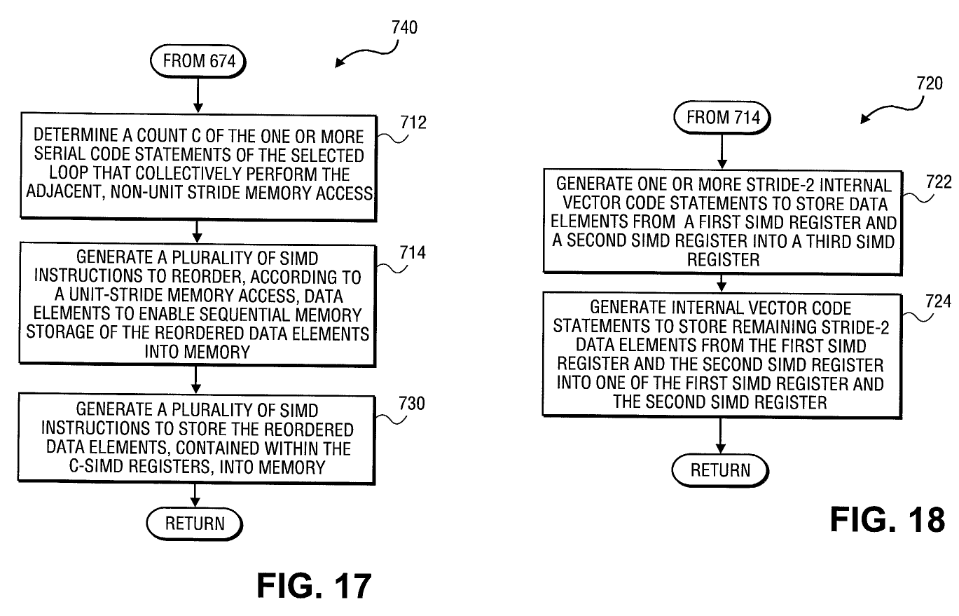

Referring now to FIG. 17, FIG. 17 depicts a flowchart illustrating an additional method 740 for generating vector code statements of process block 674, as depicted in FIG. 14. At process block 712, the system compiler determines a count (C) of the one or more serial code statements of the selected loop that collectively perform adjacent, non-unit stride memory access. Once determined, at process block 714, the system compiler generates a plurality of SIMD instruction statements to reorder, according to a unit-stride memory access pattern, data elements stored within C-SIMD registers according to a C-stride memory access pattern.

In other words, as depicted with reference to FIG. 7, corresponding stride-2 data elements (X) are contained in XMM0 register 460. Likewise, corresponding stride-2 data elements (0) are initially contained within XMM1 register 470. As such, based on the contents of registers XMM0 and XMM1, the system compiler generates one or more SIMD instruction statements utilizing unpack instructions to reorder the stride-2 data elements within registers XMM0 460 and XMM2 470 to enable unit stride storage of the data elements within array A[i] 480. A sample of generated SIMD assembly code is provided with reference to Tables 10 and 12.

Referring now to FIG. 18, FIG. 18 depicts a flowchart illustrating an additional method 720 for generating SIMD instructions to reorder data elements of process block 714, as depicted in FIG. 17. At process block 722, the system compiler generates one or more stride-2 internal vector code statements to store data elements from a first SIMD register and a second SIMD register into a third SIMD register. In the embodiment described, the data elements are stored according to a unit stride memory access pattern. Finally, at process block 724, the system compiler generates one or more internal vector code statements to store remaining stride-2 data elements from the first SIMD data register and a second SIMD register into one of the first SIMD register and the second SIMD register. Assembly code for implementing the additional method 720, as illustrated with reference to FIG. 18, is provided within Table 10.

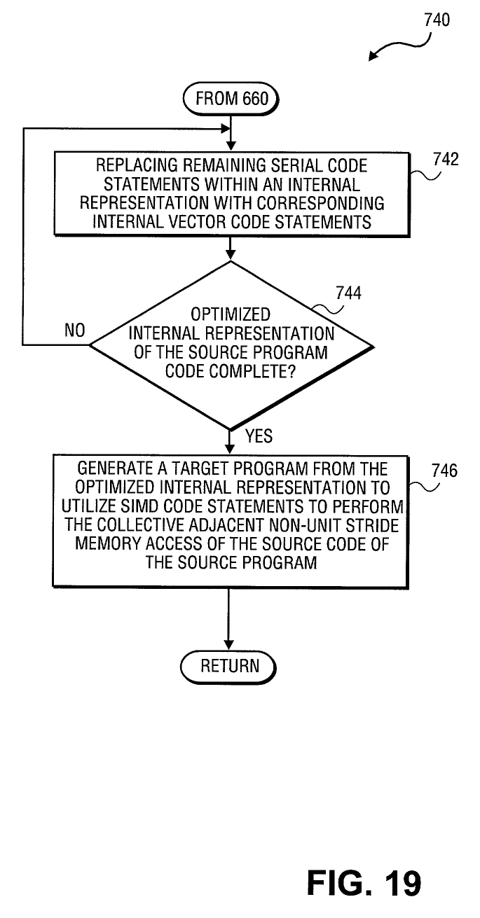

Finally, referring to FIG. 19, FIG. 19 depicts a flowchart illustrating an additional method 740 for performing vectorization of serial code statements identified to perform adjacent, non-unit stride memory access utilizing SIMD instructions in accordance with one embodiment of the present invention. At process block 742, the system compiler replaces remaining serial code statements within an internal representation of the source program with corresponding internal vector code statements. As described above, the remaining serial code statements are required to be contained within a loop, which has been determined as being vectorizable by the system compiler. Next, at process block 744, it is determined whether an optimized internal representation of the source program is complete.

As such, in the embodiment described, vectorization of identified serial code statements, as well as vectorization of identified vectorizable serial code loops results in an optimized internal representation of the source program code. Accordingly, as depicted in process block 746, the completion of the optimized internal representation of the source program code invokes process block 746. At process block 746, the system compiler generates a target program from the optimized internal representation to utilize SIMD code statements to perform the collective unit stride memory access of identified serial code statements within the source code of the source program.

Accordingly, utilizing the embodiments of the present invention, the system compiler, according to one embodiment of the present invention, is able to vectorize load/store operations which access memory according to non-unit stride load/store access patterns. In contrast to current vectorization compilers, the system compiler described herein, according to one embodiment, increases the amount of SIMD vector code that is generated during compiling of a source program. As a result, by reducing the amount of scalar code within a target program executable, source code compiled using a system compiler in accordance with embodiments of the present invention contains improved efficiency, as compared to target executable programs compiled with standard vectorization compilers.

Alternate Embodiments

Several aspects of one implementation of the system compiler embodiments for providing vectorization of adjacent, non-unit stride load/store access pattern have been described. However, various implementations of the system compiler embodiments provide numerous features including, complementing, supplementing, and/or replacing the features described above. Features can be implemented as part of the system compiler assembler or as part of the system compiler loader/link edition in different embodiment implementations. In addition, the foregoing description, for purposes of explanation, used specific nomenclature to provide a thorough understanding of the invention. However, it will be apparent to one skilled in the art that the specific details are not required in order to practice the embodiments of the invention.

In addition, although an embodiment described herein is directed to a vectorizing system compiler, it will be appreciated by those skilled in the art that the embodiments of the present invention can be applied to other systems. In fact, systems for vectorizing non-unit stride serial code load/store operations are within the embodiments of the present invention, without departing from the scope and spirit of the present invention. The embodiments described above were chosen and described in order to best explain the principles of the invention and its practical applications. These embodiments were chosen to thereby enable others skilled in the art to best utilize the invention and various embodiments with various modifications as are suited to the particular use contemplated.

It is to be understood that even though numerous characteristics and advantages of various embodiments of the present invention have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Changes may be made in detail, especially matters of structure and management of parts within the principles of the embodiments of the present invention to the full extent indicated by the broad general meaning of the terms in which the appended claims are expressed.

The embodiments of the present invention provides many advantages over known techniques. In one embodiment, the present invention includes the ability to automatically perform vectorization of serial code statements that collectively perform adjacent, non-unit (unit-stride) stride memory access. As a result, by vectorizing loops containing special kinds of non-unit stride memory access, one embodiment of the present invention increases the number of loops in serial code that can be converted into efficient instructions that exploit SIMD techniques, such as streaming SIMD extensions (SSE/SSE2) that support operations on packed single and double precision floating point memory, as well as packed integer data elements.

Consequently, by limiting the amount of serial codes found within loops of source program code, the assembly language and eventual target executable program code generated by compilers utilizing embodiments of the present invention results in more efficient performance of source program code utilizing streaming SIMD extensions. In addition, source code programmers are spared the obligation of generating assembly level code in order to take advantage of streaming SIMD extensions.

Having disclosed exemplary embodiments and the best mode, modifications and variations may be made to the disclosed embodiments while remaining within the scope of the invention as defined by the following claims.

What is claimed is:

1. A method comprising:
analyzing a source program to detect vectorizable loops having one or more serial code statements that collectively perform adjacent, non-unit stride memory access; and
vectorizing serial code statements of each detected loop to perform adjacent, non-unit stride memory access utilizing SIMD instructions.

2. The method of claim 1, wherein analyzing further comprises:
selecting a vectorizable program loop from one or more detected vectorizable program loops of the source program;
analyzing serial code statements of the selected loop to determine whether one or more of the serial code statements collectively perform adjacent, non-unit stride memory access;
when one or more of the serial code statements of the selected loop collectively perform adjacent, non-unit stride memory access, identifying the one or more serial code statements of the selected loop for vectorization utilizing SIMD instructions; and
repeating the selecting and vectorizing for each vectorizable loop within the source program.

3. The method of claim 2, wherein analyzing further comprises:
scanning the serial code of the selected loop to detect successive, serial code statements that perform non-unit stride memory access;
when successive, serial code statements that perform non-unit stride memory access are detected, determining whether the successive code statements collectively access adjacent memory elements; and
when the successive serial code statements collectively access adjacent memory elements, identifying the selected loop as containing serial code statements that collectively perform adjacent, non-unit stride memory access.

4. The method of claim 1, wherein analyzing further comprises:
generating an internal representation of the source program code to enable vectorization analysis of serial code within the source program;
scanning the internal representation of source code of the source program to detect serial code loops;
when a serial code loop is detected, analyzing the detected loop to determine whether vector code can be utilized to replace serial code within the detected code loop;
when vector code replacement of serial code within the loop is detected, identifying the detected serial code loop as a vectorizable code loop within the internal source program representation; and
repeating the scanning, analyzing and identifying for each code loop within the source program.

5. The method of claim 1, wherein vectorizing further comprises:
selecting a loop from the one or more identified loops having one or more identified serial code statements that collectively perform adjacent, non-unit stride memory access;
generating, using an internal code representation, vector code statements to perform the adjacent, non-unit stride memory access of the one or more serial code statements of the selected loop;
replacing the one or more identified serial code statements with the generated vector code statements within an internal representation of the source program; and
repeating the selecting, generation and replacing for each identified loop.

6. The method of claim 5, wherein generating further comprises:
determining a count K of the one or more serial code statements of the selected loop that collectively perform the adjacent, non-unit stride memory access;
generating internal SIMD code statements to load adjacent memory elements into K-SIMD registers according to the one or more serial code statements; and
generating a plurality of internal SIMD code statements to reorder corresponding data elements, loaded within the plurality of SIMD registers, into respective registers according to a stride-K memory access pattern, to enable SIMD processing of the corresponding stride-K data elements.

7. The method of claim 6, wherein generating SIMD instructions to load adjacent memory elements further comprises:
generating an SIMD instruction to load N-adjacent data elements into a first SIMD register;
generating a second SIMD instruction to load a next N-adjacent data elements into a second SIMD register;
generating one or more SIMD code statements to store corresponding data elements from the first and second SIMD registers into a temporary SIMD register, according to a stride-2 memory access pattern; and
generating one or more SIMD code statements to store remaining data elements from the first and second SIMD registers into one of the first and second SIMD register, according to a stride-2 memory access pattern.

8. The method of claim 5, wherein generating further comprises:
determining a count K of the one or more serial code statements of the selected loop that collectively perform the adjacent, non-unit stride memory access;
generating a plurality of SIMD instructions to reorder, according to a unit-stride memory access, data elements stored within K-SIMD registers according to a K-stride memory access pattern to enable sequential memory storage of the reordered data elements into memory; and
generating a plurality of SIMD instructions to store the reordered data elements, contained within the K-SIMD registers, into memory.

9. The method of claim 8, wherein generating SIMD instruction to reorder data elements further comprises:
generating one or more stride-2 internal vector code statements to store, according to a unit-stride memory access pattern, data elements from a first SIMD register and a second SIMD register into a third SIMD register; and
generating one or more internal vector code statements to store, according to the unit-stride memory access pattern, remaining stride-2 data elements from the first SIMD register and the second SIMD register into one of the first SIMD register and the second SIMD register.

10. The method of claim 1, further comprising:
replacing remaining serial code statements within an internal representation of the source program, and contained within a vectorizable loop, with corresponding internal vector code statements; and
once an optimized internal representation of the source program code is complete, generating a target program from the optimized internal representation to utilize SIMD code statements to perform the collective adjacent, non-unit stride memory access of the source code of the source program.

11. A computer readable storage medium including program instructions that direct a computer to perform one or more operations when executed by a processor, the one or more operations comprising:
analyzing a source program to detect vectorizable loops having one or more serial code statements that collectively perform adjacent, non-unit stride memory access; and
vectorizing serial code statements of each detected loop to perform adjacent, non-unit stride memory access utilizing SIMD instructions.

12. The computer readable storage medium of claim 11, wherein analyzing further comprises:
selecting a vectorizable program loop from one or more detected vectorizable program loops of the source program;
analyzing serial code statements of the selected loop to determine whether one or more of the serial code statements collectively perform adjacent, non-unit stride memory access;
when one or more of the serial code statements of the selected loop collectively perform adjacent, non-unit stride memory access, identifying the one or more serial code statements of the selected loop for vectorization utilizing SIMD instructions; and
repeating the selecting and vectorizing for each vectorizable loop within the source program.

13. The computer readable storage medium of claim 12, wherein analyzing further comprises:
scanning the serial code of the selected loop to detect successive, serial code statements that perform non-unit stride memory access;
when successive, serial code statements that perform non-unit stride memory access are detected, determining whether the successive code statements collectively access adjacent memory elements; and
when the successive serial code statements collectively access adjacent memory elements, identifying the selected loop as containing serial code statements that collectively perform adjacent, non-unit stride memory access.

14. The computer readable storage medium of claim 11, wherein analyzing further comprises:
generating an internal representation of the source program code to enable vectorization analysis of serial code within the source program;
scanning the internal representation of source code of the source program to detect serial code loops;
when a serial code loop is detected, analyzing the detected loop to determine whether vector code can be utilized to replace serial code within the detected code loop;
when vector code replacement of serial code within the loop is detected, identifying the detected serial code loop as a vectorizable code loop within the internal source program representation; and
repeating the scanning, analyzing and identifying for each code loop within the source program.

15. The computer readable storage medium of claim 11, wherein vectorizing further comprises:
selecting a loop from the one or more detected loops having one or more serial code statements that collectively perform adjacent, non-unit stride memory access;
generating, using an internal code representation, vector code statements to perform the adjacent, non-unit stride memory access of the one or more serial code statements of the selected loop;
replacing the one or more identified serial code statements with the generated vector code statements within an internal representation of the source program; and
repeating the selecting, generation and replacing for each detected loop.

16. The computer readable storage medium of claim 15, wherein generating further comprises:
determining a count K of the one or more serial code statements of the selected loop that collectively perform the adjacent, non-unit stride memory access;
generating internal SIMD code statements to load adjacent memory elements into K-SIMD registers according to the one or more serial code statements; and
generating a plurality of internal SIMD code statements to reorder corresponding data elements, loaded within the plurality of SIMD registers, into a respective register according to a stride-K memory access pattern to enable SIMD processing of the corresponding stride-K data elements.

17. The computer readable storage medium of claim 16, wherein generating SIMD instructions to load adjacent memory elements further comprises:
generating an SIMD instruction to load N-adjacent data elements into a first SIMD register;
generating a second SIMD instruction to load a next N-adjacent data elements into a second SIMD register;
generating one or more SIMD code statements to store corresponding data elements from the first and second SIMD registers into a temporary SIMD register, according to a stride-2 memory access pattern; and
generating one or more SIMD code statements to store remaining data elements from the first and second SIMD registers into one or the first and second SIMD register, according to a stride-2 memory access pattern.

18. The computer readable storage medium of claim 15, wherein generating further comprises:
determining a count K of the one or more serial code statements of the selected loop that collectively perform the adjacent, non-unit stride memory access;
generating a plurality of SIMD) instructions to reorder according to a unit-stride memory access, data elements stored within K-SIMD registers according to a K-stride memory access pattern to enable sequential memory storage of the reordered data elements into memory; and
generating a plurality of SIMD instructions to store the reordered data elements, contained within the K-SIMD registers, into memory.

19. The computer readable storage medium of claim 18, wherein generating SIMD instruction to reorder data elements further comprises:
generating one or more stride-2 internal vector code statements to store, according to a unit-stride memory access pattern, data elements according from a first SIMD register and a second SIMD register into a third SIMD register; and
generating one or more internal vector code statements to store, according to the unit-stride memory access pattern, remaining stride-2 data elements from the first SIMD register and the second SIMD register into one of the first SIMD register and the second SIMD register.

20. The computer readable storage medium of claim 11, further comprising:
replacing remaining serial code statements within an internal representation of the source program and contained within a vectorizable loop, with corresponding internal vector code statement; and
once an optimized internal representation of the source program code is complete, generating a target program from the optimized internal representation to utilize SIMD code statements to perform the collective adjacent, non-unit stride memory access of the source code of the source program.

21. A system, comprising:
a processor having circuitry to execute instructions;
a system interface coupled to the processor, the system interface to receive source programs, and to provide target optimize programs once compiled from the source program;
a storage device coupled to the processor, having sequences of compiler instructions stored therein, which when executed by the processor cause the processor to:
analyze a source program to detect vectorizable loops having one or more serial code statements that collectively perform adjacent, non-unit stride memory access, and
vectorize serial code statements of each detected loop to perform adjacent, non-unit stride memory access utilizing SIMD instructions.

22. The system of claim 21, wherein the instruction to analyze further causes the processor to:
select a vectorizable program loop from one or more detected vectorizable program loops of the source program;
analyze serial code statements of the selected loop to determine whether one or more of the serial code statements collectively perform adjacent, non-unit stride memory access;
when one or more of the serial code statements of the selected loop collectively perform adjacent, non-unit stride memory access, identify the one or more serial code statements of the selected loop for vectorization utilizing SIMD instructions; and
repeat the select and vectorize instructions for each vectorizable loop within the source program.

23. The system of claim 22, wherein the instruction to analyze further causes the processor to:
scan the serial code of the selected loop to detect successive, serial code statements that perform non-unit stride memory access;
when successive, serial code statements that perform non-unit stride memory access are detected, determine whether the successive code statements collectively access adjacent memory elements; and
when the successive serial code statements collectively access adjacent memory elements, identify the selected loop as containing serial code statements that collectively perform adjacent, non-unit stride memory access.

24. The system of claim 21, wherein the instruction to analyze further causes the processor to:
generate an internal representation of the source program code to enable vectorization analysis of serial code within the source program;
scan the internal representation of source code of the source program to detect serial code loops;
when a serial code loop is detected, analyze the detected loop to determine whether vector code can be utilized to replace serial code within the detected code loop;
when vector code replacement of serial code within the loop is detected, identify the detected serial code loop as a vectorizable code loop within the internal source program representation; and
repeat the scan, analyze and identify instructions for each code loop within the source program.

25. The system of claim 21, wherein the instruction to vectorize further causes the processor to:
select a loop from the one or more identified loops having one or more identified serial code statements that collectively perform adjacent, non-unit stride memory access;
generate, using an internal code representation, vector code statements to perform the adjacent, non-unit stride memory access of the one or more serial code statements of the selected loop;
replace the one or more identified serial code statements with the generated vector code statements within an internal representation of the source program; and
repeat the select, generate and replace instructions for each identified loop.

26. The system of claim 25, wherein the instruction to generate further causes the processor to:
determine a count K of the one or more serial code statements of the selected loop that collectively perform the adjacent, non-unit stride memory access;
generate internal SIMD code statements to load adjacent memory elements into K-SIMD registers according to the one or more serial code statements; and
generate a plurality of internal SIMD code statements to reorder corresponding data elements, loaded within the plurality of SIMD registers, into respective registers according to a stride-K memory access pattern, to enable SIMD processing of the corresponding stride-K data elements.

27. The system of claim 26, wherein the instruction to generate further causes the processor to:
generate an SIMD instruction to load N-adjacent data elements into a first SIMD register;
generate a second SIMD instruction to load a next N-adjacent data elements into a second SIMD register;
generate one or more SIMD code statements to store corresponding data elements from the first and second SIMD registers into a temporary SIMD register, according to a stride-2 memory access pattern; and
generate one or more SIMD code statements to store remaining data elements from the first and second SIMD registers into one of the first and second SIMD register, according to a stride-2 memory access pattern.

28. The system of claim 25, wherein the instruction to generate further causes the processor to:
determine a count K of the one or more serial code statements of the selected loop that collectively perform the adjacent, non-unit stride memory access;
generate a plurality of SIMD instructions to reorder, according to a unit-stride memory access, data elements stored within K-SIMD registers according to a K-stride memory access pattern to enable sequential memory storage of the reordered data elements into memory; and
generate a plurality of SIMD instructions to store the reordered data elements, contained within the K-SIMD registers, into memory.

29. The system of claim 28, wherein the instruction to generate further causes the processor to:
generate one or more stride-2 internal vector code statements to store, according to a unit-stride memory access pattern, data elements from a first SIMD register and a second SIMD register into a third SIMD register; and
generate one or more internal vector code statements to store, according to the unit-stride memory access pattern, remaining stride-2 data elements from the first SIMD register and the second SIMD register into one of the first SIMD register and the second SIMD register.

30. The system of claim 21, wherein the processor is further caused to:
replace remaining serial code statements within an internal representation of the source program, and contained within a vectorizable loop, with corresponding internal vector code statements; and
once an optimized internal representation of the source program code is complete, generate a target program from the optimized internal representation to utilize SIMD code statements to perform the collective adjacent, non-unit stride memory access of the source code of the source program.
